(19) United States
(12) Patent Application Publication
(10) Pub. No.: US 2012/0242241 A1
(43) Pub. Date: Sep. 27, 2012

(54) LIGHTING APPARATUS WITH AT LEAST ONE LED

(75) Inventor: Thomas Schmacht, Erdweg (DE)

(73) Assignee: OSRAM AG, Muenchen (DE)

(21) Appl. No.: 13/426,871

(22) Filed: Mar. 22, 2012

(30) Foreign Application Priority Data
Mar. 23, 2011 (DE) 10 2011 005 968.7

(51) Int. Cl. H05B 41/36

(52) U.S. Cl. 315/210

(57) ABSTRACT

The present invention relates to a lighting apparatus with at least one LED, in particular an LED retrofit, in which a surge arrester whose breakdown voltage is above the maximum system voltage and below the starting voltage of the fluorescent lamp which is intended to be replaced by a lighting apparatus according to an embodiment. In this way, a lighting apparatus according to an embodiment can be operated using the ballast originally designed for a fluorescent lamp, wherein, moreover, a risk to an operator when inserting a lighting apparatus according to an embodiment into a luminaire can reliably be ruled out.

### CROSS REFERENCE TO RELATED APPLICATION

This application claims priority to German application No. DE 12 2011 005 968.7 filed on Mar. 23, 2011 which is hereby incorporated by reference in its entirety.

### FIELD

An embodiment relates to a lighting apparatus with at least one LED, comprising a first terminal, which comprises a first terminal pole and a second terminal pole, and a second terminal, which comprises a third terminal pole and a fourth terminal pole.

### BACKGROUND

In recent times, attempts have increasingly been made to provide so-called LED retrofits which can be used to replace fluorescent lamps. The aim here is to keep the required conversion measures to a minimum and nevertheless to ensure sufficient safety for an operator during the replacement. The replacement of fluorescent lamps with so-called LED retrofits is preferred because LEDs have higher efficiency and a longer life.

One problem with the procedures known from the prior art is that replacing the fluorescent lamps directly with LED retrofits is not possible without needing to modify the luminaire in some way. Without corresponding modifications, there is the risk with the LED retrofits known from the prior art of an operator receiving an electric shock when inserting the LED retrofit into a luminaire on one side when said operator touches the unused contacts.

In order to prevent this undesirable event, it is known from the prior art to reconstruct the luminaire completely so as to be suitable for LED operation, wherein in this case the ballast operating the fluorescent lamp also needs to be replaced. This represents considerable complexity and is therefore undesirable. In another known procedure, the starter in the luminaire is replaced by a fuse. Such actions cannot usually be performed by a private individual, and therefore this procedure is likewise unsatisfactory.

### SUMMARY

An object of an embodiment therefore consists in developing a lighting apparatus of this generic type such that it firstly provides the possibility of replacement of a fluorescent lamp without any modifications to the luminaire into which the fluorescent lamp was inserted and secondly reliably rules out any risk to an operator who is inserting such a lighting apparatus into the luminaire.

These objects achieved by a lighting apparatus having the features of patent claim 1.

An embodiment is based on the knowledge that, in an LED retrofit, a surge arrester whose spark overvoltage is greater than the system voltage but lower than the starting voltage of the originally inserted fluorescent lamp is used firstly to provide protection against electric shock and secondly to provide the possibility of the lighting apparatus according to an embodiment being switched on and operated via the surge arrester which breaks down when the starting voltage is applied by the ballast designed for operation of a fluorescent lamp.

Therefore, for a lighting apparatus of this generic type, an embodiment provides that the first terminal pole and the second terminal pole are coupled to one another so as to form a first coupling point, the third terminal pole and the fourth terminal pole being coupled to one another so as to form a second coupling point. According to an embodiment, a breakdown apparatus with a predeterminable breakdown voltage, an electronic switch, which is connected in parallel with the breakdown apparatus, a driver apparatus (12) for the at least one LED with an input, which comprises a first input terminal and a second input terminal, and an output for coupling to the at least one LED, a drive circuit for the electronic switch, the drive circuit comprising a current measuring apparatus, the drive circuit being designed to switch the electronic switch on when a current above a predeterminable threshold value is found, the first input terminal and the second input terminal of the driver apparatus, the parallel circuit comprising the breakdown apparatus and the electronic switch and also the current measuring apparatus being coupled in series between the first coupling point and the second coupling point.

A lighting apparatus according to an embodiment can therefore replace a fluorescent lamp without the need for modifications to the luminaire, with it being possible for the risk of electric shock for a user to be reliably ruled out.

Preferably, the breakdown apparatus is in the form of an electrical breakdown apparatus, in particular in the form of a surge arrester. By virtue of the use of in particular a surge arrester, mechanical separation of the two terminal sides of the breakdown apparatus is provided, with the result that capacitive transmission of energy to that side of the lighting apparatus which has not yet been inserted into the luminaire is reliably ruled out. By way of example, this would not be the case with a triac.

Preferably, the electronic switch is in the form of a mechanical switch, in particular in the form of a relay. In this case, too, mechanical separation is necessary between that side of a lighting apparatus which is inserted into the luminaire and the side which has not yet been inserted. A relay allows a dielectric strength of up to 4 kV, in which case it should be borne in mind that the permissible touch voltage is 35 V. A transistor circuit would not be suitable for reducing the high starting voltages provided by the ballast, which is still being used but was originally designed for operation of a fluorescent lamp, to a value below the permissible touch voltage.

In a further preferred embodiment, a first ohmic resistor is coupled between the first terminal pole and the first coupling point and/or a second ohmic resistor is coupled between the second terminal pole and the first coupling point and/or a third ohmic resistor is coupled between the third terminal pole and the second coupling point and/or a fourth ohmic resistor is coupled between the fourth terminal pole and the second coupling point. In this way, the filament resistance of the originally used fluorescent lamp can be simulated, as a result of which operation of the LED retrofit is also made possible when using ballasts with filament resistance identification. In order to minimize the losses which are converted in these resistances, two ohmic resistors are preferably used per terminal. Particularly preferably, the first ohmic resistor and the second ohmic resistor and/or the third ohmic resistor and the fourth ohmic resistor are equal in value. This takes account of the fact that it is not possible to predict which of the terminal poles will conduct current once a lighting apparatus according to an embodiment has been inserted into a luminaire. This ensures, in any event, that the filament resistance of the original fluorescent lamp is firstly simulated and secondly the losses in the operating means as a result of these ohmic resistors are minimal. As has already been mentioned, the sum of the values of the first ohmic resistor and the second ohmic resistor and the sum of the values of the third ohmic resistor and the fourth ohmic resistor particularly preferably correspond to a predeterminable filament resistance of a fluorescent lamp, in particular the fluorescent lamp originally inserted into the luminaire.

In order to allow insertion without any problems, provision is preferably made for the lighting apparatus to further comprise a housing, the housing corresponding in terms of its dimensions to the housing of a fluorescent lamp, in particular the fluorescent lamp originally inserted into the luminaire.

Preferably, the current measuring apparatus comprises a transformer, in particular a current transformer, with a primary inductance and a secondary inductance, the primary inductance being part of said series circuit. When the electronic switch is in the form of a relay, see above, the relay and the transformer are preferably designed such that, during operation of the lighting apparatus, the operating current through the primary inductance of the transformer generates a voltage on the secondary side of the transformer which keeps the relay switched on. When the relay is switched on, accordingly the electronic switch as provided by the relay is closed, with the operating current for operating the at least one LED being maintained via this closed electronic switch.

Particularly preferably, the breakdown voltage of the breakdown apparatus is between a maximum system AC voltage which can be coupled to the first or second terminal and a starting voltage which is predetermined for a fluorescent lamp, in particular a fluorescent lamp whose housing has the same dimensions as the housing of the lighting apparatus according to an embodiment. This ensures that, when using a lighting apparatus according to an embodiment in which one of the terminal poles comes into contact with the system voltage, this system voltage is not transmitted to that side of the lighting apparatus which has not yet been inserted. First, the starting voltage applied to the lighting apparatus according to an embodiment by the ballast causes the breakdown apparatus to break down and then enables operation of the at least one LED. By virtue of this procedure, the features of a ballast which was originally designed for operation of a fluorescent lamp are now used in optimum fashion for operating the at least one LED in the same luminaire, wherein at no point is there any risk to an operator inserting a lighting apparatus according to an embodiment into a luminaire.

Further advantageous embodiments can be gleaned from the dependent claims.

### BRIEF DESCRIPTION OF THE DRAWING(S)

An exemplary embodiment of a lighting apparatus according to an embodiment will now be described in more detail below with reference to the attached drawing, which shows a schematic illustration of an exemplary embodiment of a lighting apparatus according to an embodiment.

### DETAILED DESCRIPTION

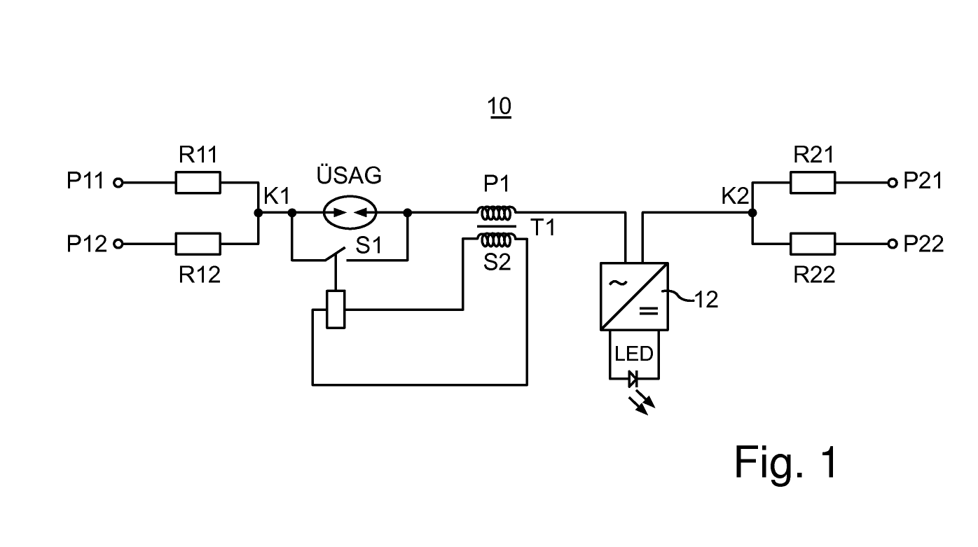

FIG. 1 shows a schematic illustration of an exemplary embodiment of a lighting apparatus 10 according to an embodiment which is arranged in particular in a housing (not illustrated), which is identical, in terms of its dimensions, to the housing of the fluorescent lamp which the lighting apparatus according to an embodiment is intended to replace as a so-called LED retrofit.

Corresponding to a fluorescent lamp, a first terminal is provided, with a first terminal pole P11 and a second terminal pole P12, and a second terminal is provided, with a third terminal pole P21 and a fourth terminal pole P22. The first terminal pole P11 is coupled, via a first ohmic resistor R11, to a first coupling point K1, to which the second terminal pole P12 is coupled on the other side via an ohmic resistor R12. Correspondingly, the third terminal pole P21 is coupled, via an ohmic resistor R21, to a second coupling point K2, to which the fourth terminal pole P22 is likewise coupled via an ohmic resistor R22. The sum of the values of the ohmic resistors R11 and R12 and R21 and R22 serves the purpose of simulating the filament resistance Rfilament of the fluorescent lamp originally inserted into the luminaire, i.e. R11+R12=Rfilament and R21+R22=Rfilament. Thus, a lighting apparatus according to an embodiment can also be used and operated in electronic ballasts with identification of the filament resistance. Such electronic ballasts set specific operating parameters depending on the filament resistance identified.

The lighting apparatus 10 according to an embodiment further comprises a surge arrester ÜSAG with a predeterminable breakdown voltage. An electronic switch S1 is connected in parallel with the surge arrester ÜSAG. Furthermore, a driver apparatus 12 is provided for the at least one LED, the input of the driver apparatus 12 comprising a first input terminal and a second input terminal as well as an output for coupling to the at least one LED. A transformer T1, which acts as current transformer, has a primary inductance P1 and a secondary inductance S2. The electronic switch S1 is in the form of a relay and is coupled to the secondary inductance S2. The primary inductance P1 is connected in series with the parallel circuit comprising the surge arrester ÜSAG and the switch S1, as well as the driver apparatus 12, between the coupling points K1 and K2. The breakdown voltage of the surge arrester ÜSAG is selected such that it is greater than the system voltage which is coupled to one of the terminal poles P11, P12, P21, P22 when the lighting apparatus 10 is inserted into a luminaire, in order that the surge arrester ÜSAG does not respond as early as when the lighting apparatus 10 is inserted only one side. Secondly, the breakdown voltage of the surge arrester ÜSAG is selected to be lower than the starting voltage of the fluorescent lamp originally inserted into the luminaire, with the result that the surge arrester ÜSAG breaks down owing to the starting voltage applied to the lighting apparatus 10.

However, this is the case only once all four terminal poles so the lighting apparatus 10 have been inserted into the luminaire, with the result that there is no longer any risk to an operator at this time.

If a voltage is applied between the terminal pins P11 and P12, on the one hand, and P21 and P22, on the other hand, this voltage is also present across the surge arrester ÜSAG since, in the deenergized state, there is no voltage drop across the resistors R11 to R22, the driver apparatus 12 and the transformer T1.

If the voltage applied to the terminal pins P11 to P22 reaches the breakdown voltage of the surge arrester ÜSAG, said surge arrester operates. As a result, the voltage drop across the surge arrester ÜSAG is reduced, for example to 24 V. In consequence of this, a current flows between the terminal pins via the respective ohmic resistors, the driver apparatus 12 and the transformer T1. The driver apparatus 12 receives virtually the entire voltage applied to the terminal poles P11 to P22 owing to the low voltage drops across the remaining components.

The current flow results in a voltage across the primary inductance P1 and therefore across the secondary inductance S2. This voltage allows the relay L1 to pick up, as a result of which the surge arrester ÜSAG is short-circuited. The relay S1 therefore carries the operating current. As a result of the operating current now flowing, the relay continues to remain closed. The relay is now latched. In this state, the driver apparatus 12 continues to be supplied with voltage.

On disconnection, the relay S2 releases as soon as the current flow is so low that the voltage generated on the secondary side S2 of the transformer T1 is no longer sufficient for holding the relay S1.

1. A lighting apparatus with at least one LED, comprising:
a first terminal, which comprises a first terminal pole and a second terminal pole; and
a second terminal, which comprises a third terminal pole and a fourth terminal pole;
characterized
in that the first terminal pole and the second terminal pole are coupled to one another so as to form a first coupling point, the third terminal pole and the fourth terminal pole being coupled to one another so as to form a second coupling point;
the lighting apparatus further comprising:
a breakdown apparatus with a predeterminable breakdown voltage;
an electronic switch, which is connected in parallel with the breakdown apparatus;
a driver apparatus for the at least one LED with an input, which comprises a first input terminal and a second input terminal, and an output for coupling to the at least one LED;
a drive circuit for the electronic switch, the drive circuit comprising a current measuring apparatus, the drive circuit being designed to switch the electronic switch on when a current above a predeterminable threshold value is found;
the first input terminal and the second input terminal of the driver apparatus, the parallel circuit comprising the breakdown apparatus and the electronic switch and also the current measuring apparatus being coupled in series between the first coupling point and the second coupling point.

2. The lighting apparatus as claimed in claim 1, characterized
in that the breakdown apparatus is in the form of an electrical breakdown apparatus, in particular in the form of a surge arrester.

3. The lighting apparatus as claimed in claim 1, characterized
in that the electronic switch is in the form of a mechanical switch, in particular in the form of a relay.

4. The lighting apparatus as claimed in claim 1, characterized
in that a first ohmic resistor is coupled between the first terminal pole and the first coupling point and/or a second ohmic resistor is coupled between the second terminal pole and the first coupling point and/or a third ohmic resistor is coupled between the third terminal pole and the second coupling point and/or a fourth ohmic resistor is coupled between the fourth terminal pole and the second coupling point.

5. The lighting apparatus as claimed in claim 4, characterized
in that the first ohmic resistor and the second ohmic resistor and/or the third ohmic resistor and the fourth ohmic resistor are equal in value.

6. The lighting apparatus as claimed in claim 4, characterized
in that the sum of the values of the first ohmic resistor and the second ohmic resistor and the sum of the values of the third ohmic resistor and the fourth ohmic resistor correspond to a predeterminable filament resistance of a fluorescent lamp.

7. The lighting apparatus as claimed in claim 1, characterized
in that the lighting apparatus further comprises a housing, the housing corresponding in terms of its dimensions to the housing of a fluorescent lamp.

8. The lighting apparatus as claimed in claim 1, characterized
in that the current measuring apparatus comprises a transformer, in particular a current transformer, with a primary inductance and a secondary inductance, the primary inductance being part of said series circuit.

9. The lighting apparatus as claimed in claim 8, characterized
in that the relay and the transformer are designed such that, during operation of the lighting apparatus, the operating current through the primary inductance of the transformer generates a voltage on the secondary side of the transformer which keeps the relay switched on.

10. The lighting apparatus as claimed in claim 1, characterized
in that the breakdown voltage of the breakdown apparatus is between a maximum system AC voltage which can be coupled to the first or second terminal and a starting voltage which can be predetermined for a fluorescent lamp, in particular a fluorescent lamp whose housing has the same dimensions as the housing of the lighting apparatus.
